(19) United States
(12) Patent Application Publication
(10) Pub. No.: US 2004/0212648 A1
(43) Pub. Date: Oct. 28, 2004

(54) Ink jet printer

(76) Inventors: Hiroaki Arakawa, Yamanashi (JP); Tetsuo Uno, Tokyo (JP)

Correspondence Address: CANTOR COLBURN LLP, 55 Griffin Road South, Bloomfield, CT, 06002, US

(21) Appl. No.: 10/827,830

(22) Filed: Apr. 20, 2004

(30) Foreign Application Priority Data
Apr. 24, 2003 (JP) JP2003-119892

(51) Int. Cl. B41J 29/38

(52) U.S. Cl. 347/14

(57) ABSTRACT

An ink jet printer for printing a frameless image on a recording medium, having an image data input section, a recording section having a nozzle for ejecting an ink based on the image data, a carriage for reciprocating the recording section in a primary scanning direction, a recording medium moving section for moving the recording medium in a sub-scanning direction, a detection sensor provided on the carriage for detecting the recording medium, wherein a detection position is set on upstream side of the nozzle. The printer further has a first memory for storing the image data received, a masking section for applying masking processing to image data corresponding to outside of the recording medium in accordance with recording medium existence information, and a control section for controlling to print an image on the recording medium by using the image data applied the masking processing.

### BACKGROUND OF THE INVENTION

The present invention relates to an ink jet printer for carrying out frameless printing.

In recent years, when printing image information on a recording medium using an ink jet printer, frameless printing leaving no blanks on the peripheral area of the recording medium is carried out. In the frameless printing, the image information is enlarged or reduced in size so as to sufficiently cover the recording medium, and image information covering the recording medium is prepared, and the image information is printed, thus frameless printing can be carried out.

On the other hand, in the frameless printing, an area larger than the recording medium is printed, so that the part of a platen, whereon the recording medium is loaded, in which the recording medium does not exist, is also printed and ink used to print the part is unnecessary and simultaneously causes soiling the platen.

To eliminate this soil, an ink absorber is arranged on the peripheral part of the recording medium which causes soil of the platen (for example, refer to Patent Document 1).

### Patent Document 1

Japanese Application Patent Laid-Open Publication No. Hei 08-169155 (pages 5 and 6, FIGS. 3 to 5)

(Problems to be Solved by the Invention)

However, according to the aforementioned prior art, ink turning away from the ink absorber is ejected onto the platen. And, at this time, the ejected ink is useless consumption and simultaneously soils the platen, thus an additional mechanism such as a collection mechanism for collecting turned-away ink or a mechanism for wiping out the platen is necessary.

Particularly, when the recording medium is arranged on the platen in a skewed manner, as the printing proceeds, the relative location between the ink absorber and the recording medium is shifted, and what is worse, the peripheral part of the recording medium is turned away from the ink absorber, and soil is caused to the platen.

Further, when recording media are different in width, the position of the ink absorber is different for each absorber width and a derivative mechanism such that the position of the ink absorber is made variable or an ink absorber including all widths of recording media is installed is required. And, use of such an ink absorber causes complication and a high price of the ink jet printer.

Therefore, in the frameless printing, it is important how to realize an ink jet printer for preventing the platen from soiling by ink without using the ink absorber.

The present invention was developed to solve the aforementioned problems due to the prior art and is intended to provide an ink jet printer, in the frameless printing, capable of preventing ink soil on the platen without using the ink absorber.

### SUMMARY OF THE INVENTION

The aforementioned problems can be solved by an ink jet printer having the following features.

An ink jet printer for printing a frameless image on a recording medium, including: an input section for receiving image data; a recording section having a nozzle for ejecting an ink based on the image data; a carriage for reciprocating the recording section in the primary scanning direction, a recording medium moving section for moving the recording medium in a sub-scanning direction perpendicular to the primary scanning direction, relatively to the recording medium; a detection sensor provided on the carriage for detecting an existence of the recording medium, wherein a detection position of the sensor is set on upstream side of the nozzle in a movement direction of the recording medium. The ink jet printer further has a first memory for storing the image data received; a masking section, in accordance with recording medium existence information detected by the detection sensor, for applying masking processing to image data corresponding to outside of the recording medium among the image data in the first memory; and a control section for controlling the ink jet printer to print an image on the recording medium by using the image data applied the masking processing.

### BRIEF DESCRIPTION OF THE DRAWINGS

FIG. 1 is a block diagram showing the entire structure of an ink jet printer.

FIG. 2 is an external view showing the recording section of Embodiment 1.

FIG. 3 is a drawing showing the carriage section of Embodiment 1.

FIG. 4 is a drawing showing the section of the detection sensor of Embodiment 1.

FIG. 5 is a flow chart showing the operation of the ink jet printer of Embodiment 1.

FIG. 6 is a flow chart showing the operation of the edge position detection processing of Embodiment 1.

FIG. 7 is a flow chart showing the operation of the skew detection processing of Embodiment 1.

FIG. 8 is a flow chart showing the operation of the edge detection processing in the primary scanning direction of Embodiment 1.

FIGS. 9(a) and 9(b) are drawings showing the position relationship between the printing area and the recording medium and the mask area.

FIG. 10 is a block diagram showing the image readout section of Embodiment 2.

FIG. 11 is a drawing showing the carriage section of Embodiment 1.

FIG. 12 is a conceptual diagram when a linear type photosensor is used.

### DETAILED DESCRIPTION OF THE PREFERRED EMBODIMENTS

The preferred embodiments of the ink jet printer relating to the present invention will be explained below with reference to the accompanying drawings. Further, the present invention is not limited to them.

### Embodiment 1

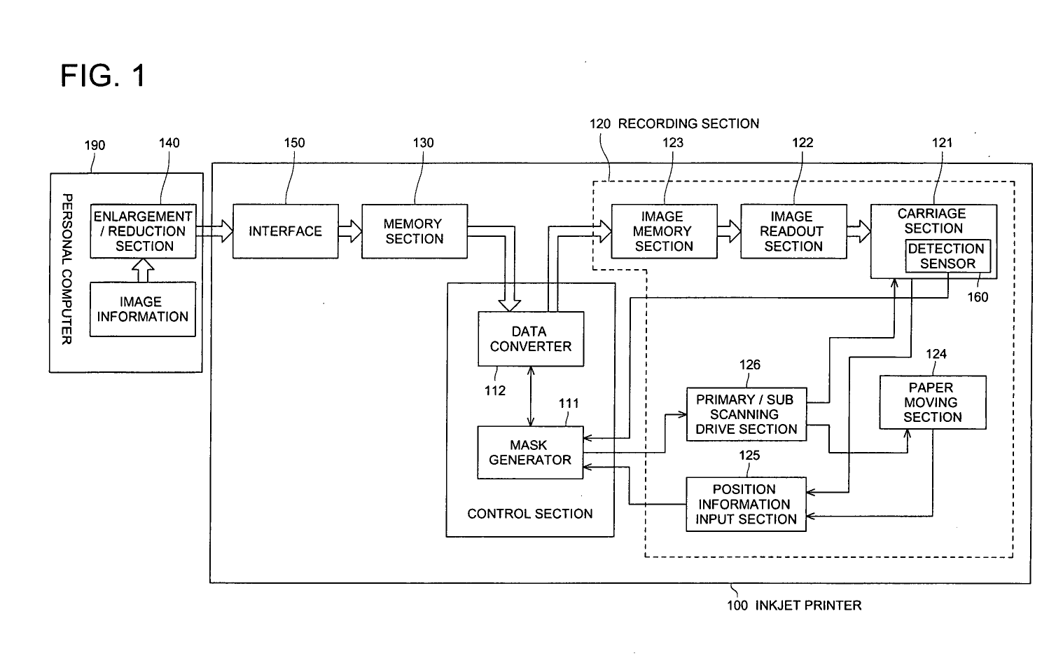

Firstly, the entire structure of an ink jet printer 100 relating to Embodiment 1 will be explained. FIG. 1 is a block diagram showing the constitution of the ink jet printer 100. The ink jet printer 100 includes a recording section 120, a control section 110, a memory section 130, and an interface 150 which is an input means. Further, in the drawing, the thick lines connecting the blocks indicate a data bus of image information and the thin lines indicate a control information bus.

The interface 150 is an input means for reading frameless image information of a personal computer 190 connected to the ink jet printer 100 via a communication line into the ink jet printer 100. In this case, the personal computer 190 includes image information and an enlargement/reduction section 140. Further, the enlargement/reduction section 140 can be built in the ink jet printer 100.

The enlargement/reduction section 140 converts image information to frameless image information converted to the image size when frameless printing is to be carried out. Here, the frameless printing, when printing image information on a recording medium, is to print the image information overall the surface without leaving blanks on the peripheral part of the recording medium. The enlargement/reduction section 140 converts input image information to a sufficient size to cover the set recording medium. At this time, when the image information is smaller than the size of the recording medium, by a procedure of interpolation, the deterioration of the image quality due to enlargement is prevented and when the image information is larger than the size of the recording medium, the image information is reduced to a size to thoroughly cover the recording medium. Further, the memory section 130 inputs and stores frameless image information enlarged or reduced by the enlargement/reduction section 140 via the interface 150.

The recording section 120 carries out frameless printing of the frameless image information on the recording medium. In this case, the recording section 120 includes a carriage section 121, a paper moving section 124, an image readout section 122, an image memory section 123, a primary/sub scanning drive section 126, and a position information input section 125.

The image memory section 123 stores the image information of the part of the frameless image information to be printed and the image information is output to the recording medium as it is from the heads of the colors C, M, Y, and K of the carriage section 121. The image readout section 122 reads out sequentially the image information of the image memory section 123 according to a predetermined procedure and outputs it to the carriage section 121.

In this case, the carriage section 121 is composed of heads, drivers, and ink cartridges of the colors C, M, Y, and K and a carriage having these units built-in. The carriage moves in the primary scanning direction perpendicular to the sub-scanning direction, which is the moving direction of the recording medium, by an instruction from the primary/sub scanning drive section 126 and carries out printing by ejection of ink. Further, the position of the carriage in the primary scanning direction is detected by an encoder with high precision and is sent to the position information input section 125.

Further, the carriage section 121 has a detection sensor 160 which is a detection means described later. The detection sensor 160 is a detection means, which detects the existence of a recording medium arranged on the platen with the accuracy of pixel unit at the time of printing and transmits the detection information to the control section 110.

The paper moving section 124 is composed of a paper moving mechanism such as a roller moving in the sub-scanning direction which is the recording medium moving direction and moves in the sub-scanning direction of the recording medium. Further, the paper moving section 124 detects roughly the movement distance in the sub-scanning direction of the recording medium by a rotary encoder attached to the roller and transmits it to the position information input section 125.

The primary/sub scanning drive section 126 moves the carriage in the primary scanning direction and moves the recording medium in the sub-scanning direction by the roller. Further, the position information input section 125 obtains position information of the carriage and rough position information of paper movement from the carriage section 121 and the paper moving section 124.

The control section 110 includes a mask generator 111 and a data converter 112. In this case, the mask generator 111, from recording medium existence information from the detection sensor 160 of the carriage section 121 and position information of the carriage inputted to the position information input section 125, detects the position and skew of the recording medium with high accuracy of pixel unit and decides a mask area of the frameless image information stored in the memory section 130.

Further, the data converter 112 substitutes a zero for the frameless image information of the memory section 130 at the pixels corresponding to the mask area generated by the mask generator 111 and outputs it to the image memory section 123.

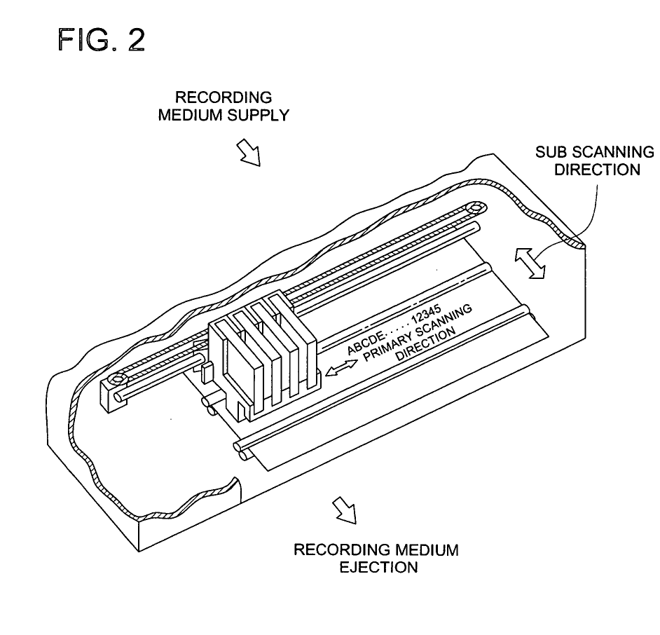

Next, the constitution of the recording section 120 around the carriage section 121 will be explained by referring to FIG. 2. FIG. 2 is a drawing showing the constitution of the recording section 120 around the carriage section 121. On a support bar 3 directed in the primary scanning direction, a carriage 2 is arranged movably in the primary scanning direction. The carriage 2 is driven on the support bar 3 by a stepping motor 5 via rollers 6a and 6b and a drive belt 4, thereby prints during moving in the primary scanning direction.

On the carriage 2, cartridges 1C, 1M, 1Y, and 1K of C, M, Y, and K are mounted removably. At the lower end of the carriage 2, there exist heads of C, M, Y, and K not shown in the drawing and from a plurality of ink ejection nozzles of each head, ink is ejected to a recording medium 7 existing on the lower part of the carriage 2.

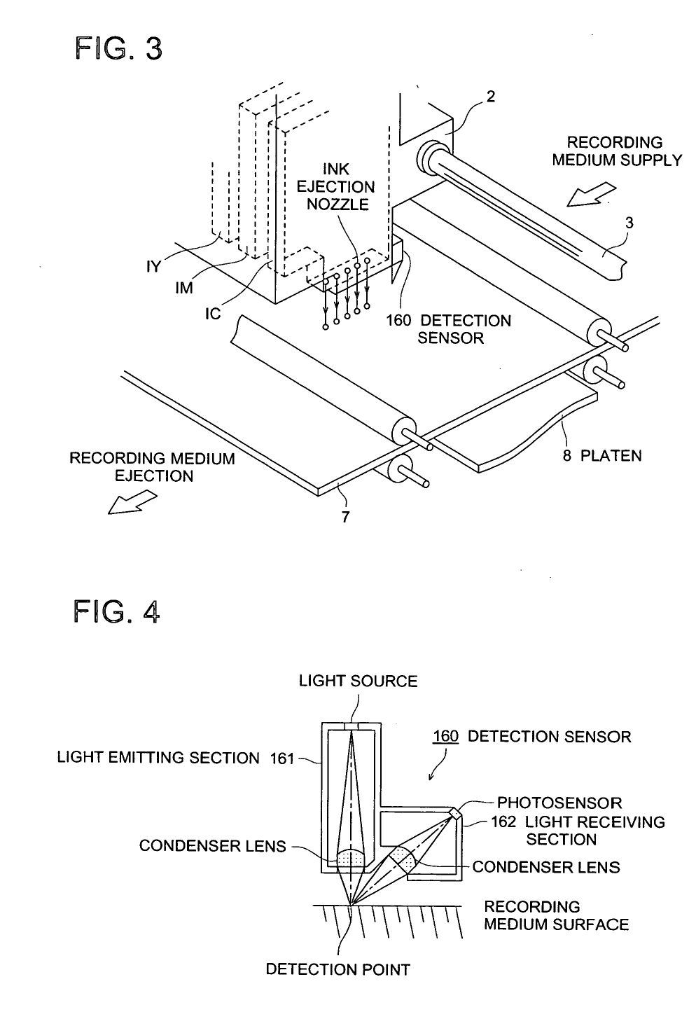

Further, FIG. 3 shows the mounting part of the detection sensor 160 mounted on the carriage 2. The detection sensor 160, which is a detection means, is mounted on the side of the carriage 2 on the recording medium supply side from the ink ejection nozzle of the head, which is positioned at the end on the recording medium supply side, of the cartridge C schematically shown in FIG. 3. In this case, the detection sensor 160 has a light emitting face and a light receiving face on the recording medium side and detects reflected light from the recording medium. Further, the detection sensor 160 is mounted on the carriage 2, so that it moves in the primary scanning direction and detects with the same accuracy as that of the heads.

Further, FIG. 4 shows the section of the detection sensor 160 which is a detection means. The detection sensor 160 is a reflection type photosensor composed of a light emitting section 161 and a light receiving section 162. The light emitting section 161 has a light source including light of red or in the infrared zone and a focusing lens for focusing light emitted from the light source on a recording medium and forms a light spot at the detection point on the recording medium. Further, the light receiving section 162 has a photosensor for detecting the reflected light from the detection point on the recording medium and a focusing lens for focusing the reflected light from the detection point on the recording medium on the photosensor.

In this case, a platen 8 of the recording medium 7 positioned on the opposite side of the detection sensor 160 is colored, for example, in black reflecting no light. Therefore, the existence of the recording medium 7 at the detection point is detected from the difference in the strength of the reflected light. Furthermore, when the light source includes light of red or in the infrared zone, even if black ink exists on the recording medium, due to the difference in the reflection factor of red light or infrared light from the black ink and the platen 8, the existence of the recording medium 7 can be distinguished without confusion.

Further, the spot diameter of light formed at the detection point on the recording medium is set to a spot diameter equal to or smaller than the size of pixels of the image information formed on the recording medium by the focusing lens. Therefore, the existence of the recording medium 7 at the spot position can be detected in the pixel unit. Further, the detection sensor 160 is mounted on the carriage 2, so that the position of the detection sensor 160 in the primary scanning direction has the accuracy of pixel unit similar to that of the carriage 2 at the time of printing. Therefore, the detection sensor 160 detects the existence of the recording medium 7 in the primary scanning direction in the pixel unit.

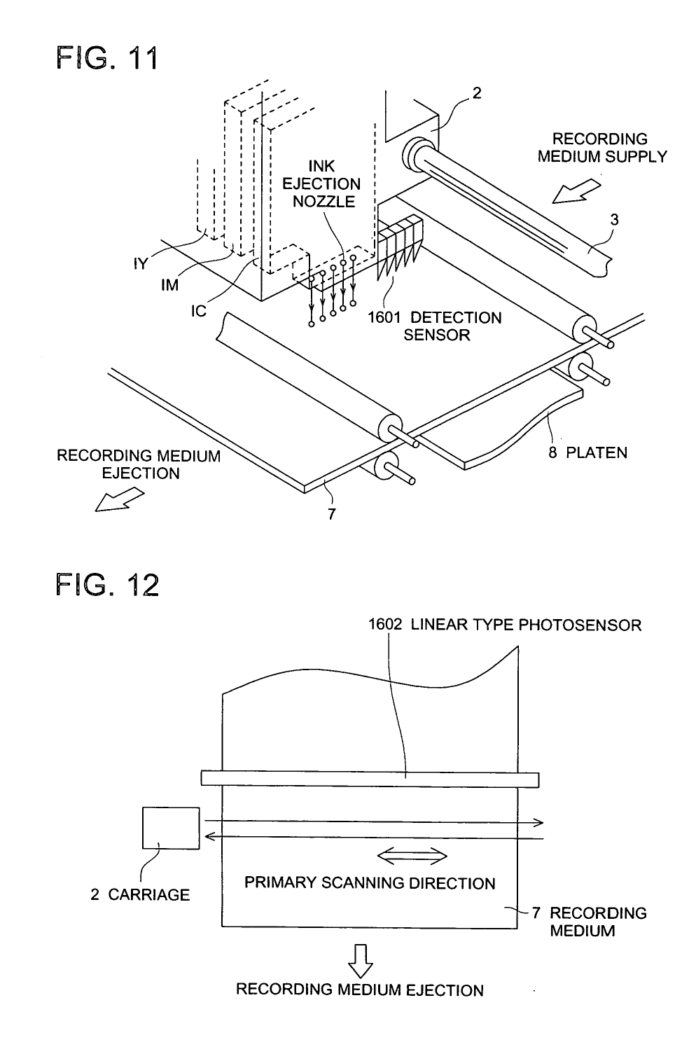

Further, as a detection sensor, as shown by 1601 in FIG. 11, a plurality of detection sensors shown in FIG. 4 may be lined up in the paper moving direction. In this case, the existence of the recording medium 7 at the detection point can be detected quickly and accurately.

Further, as a detection sensor, a linear type photosensor 1602 as shown in FIG. 12 can be used.

The linear type photosensor is composed of a photosensor arranged one-dimensionally with high precision in the primary scanning direction, so that the existence of the recording medium 7 at the detection point 7 can be detected additionally from detailed position information in the primary scanning direction. The linear type photosensor, when detecting the leading or rear edge of the recording medium 7 which will be described later, can detect the leading or rear edge position particularly in a little error.

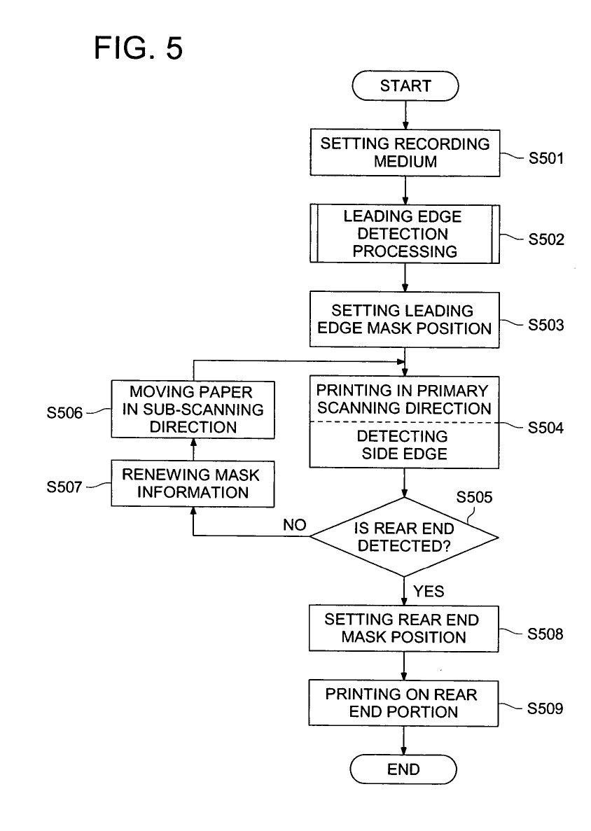

Then, the operation of the ink jet printer 100 at the time of frameless printing will be explained by referring to the flow charts shown in FIG. 5 and the subsequent drawings. Firstly, the recording medium 7 is set in the initial arrangement position of the ink jet printer 100 (Step S501). And, the control section 110 performs the leading edge detection processing of the recording medium 7 (Step S502). In the leading edge detection process, using the detection sensor 160, the leading edge position of the recording medium 7 is decided with high precision.

Further, the recording medium 7 is moved from the initial arrangement position to the carriage section 121 by the paper moving section 124. At this time, the confirmation of that the recording medium 7 is moved to the carriage section 121 is performed by using a detection means of the control section 110 which is not shown in the drawing. The detection means detects that the recording sensor 7 passes the opposite position of the detection sensor 160 which is arranged in the neighborhood of the center in the primary scanning direction.

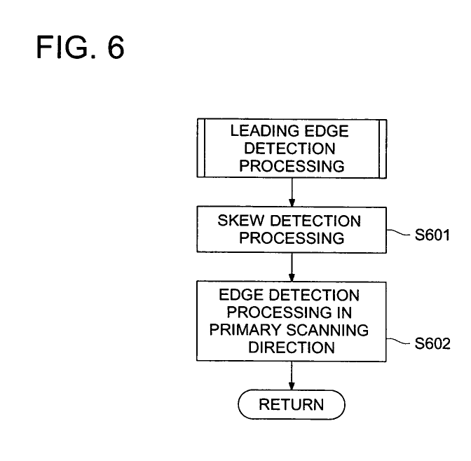

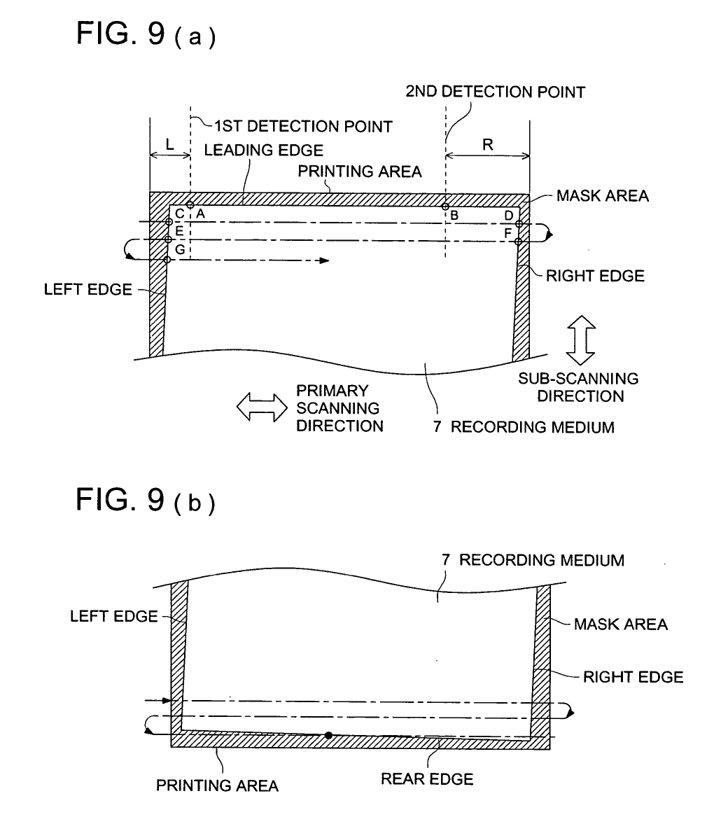

Next, before explaining the leading edge detection processing by referring to the flow chart shown in FIG. 6, by referring to FIG. 9, the printing area the frameless image information of the image memory section 123 and the position of the recording medium 7 will be explained. The frameless image information of the image memory section 123, as shown in FIGS. 9(A) and 9(B), is printed overall the printing area covering the recording medium 7. The control section 110, on the basis of the printing area information, by the movement of the carriage 2 in the primary scanning direction and the movement of the recording medium 7 in the sub-scanning direction by the paper moving mechanism, prints overall the printing area covering the recording medium 7. Further, the control section 110, on the basis of the printing area information and the position information of the recording medium 7 inputted to the position information input section 125, controls the head position of the carriage 2 in the primary scanning direction and the position of the recording medium 7 existing in the initial arrangement position in the sub-scanning direction by the paper moving mechanism and sequentially prints the recording medium 7 with a predetermined width from the leading edge of the printing area.

Further, the recording medium 7 is fetched from the initial arrangement position by the paper moving mechanism and is moved to the head position, though it may be skewed at this time. FIG. 9(A) shows an example of the position relationship between the printing area and the skewed recording medium 7. Recording media are almost lined up in the initial arrangement position, so that the skew is a comparatively small one caused during fetching or moving and the recording medium 7 is set in the printing area. Further, the mask generator 111 has a two-dimensional data area having the same size as that of the printing area and sets a mask area based on the position information of the recording medium 7 in the two-dimensional data area. In the subsequent explanation, this two-dimensional data area is used without distinguishing from the printing area.

Then, the leading edge detection processing will be explained by referring to the flow chart shown in FIG. 6. In the leading edge detection processing, the skew detection processing (Step S601) of detecting the skew of the recording medium 7 and then the edge (in the primary scanning direction) detection processing (Step S602) are performed. In the skew detection processing, the skew of the recording medium 7 in the printing area of the frameless image information is detected. Further, in the edge detection processing, the left and right edges of the recording medium 7 in the primary scanning direction are detected and together with the skew information obtained at Step S601, the position of the recording medium 7 in the printing area of the frameless image information is decided.

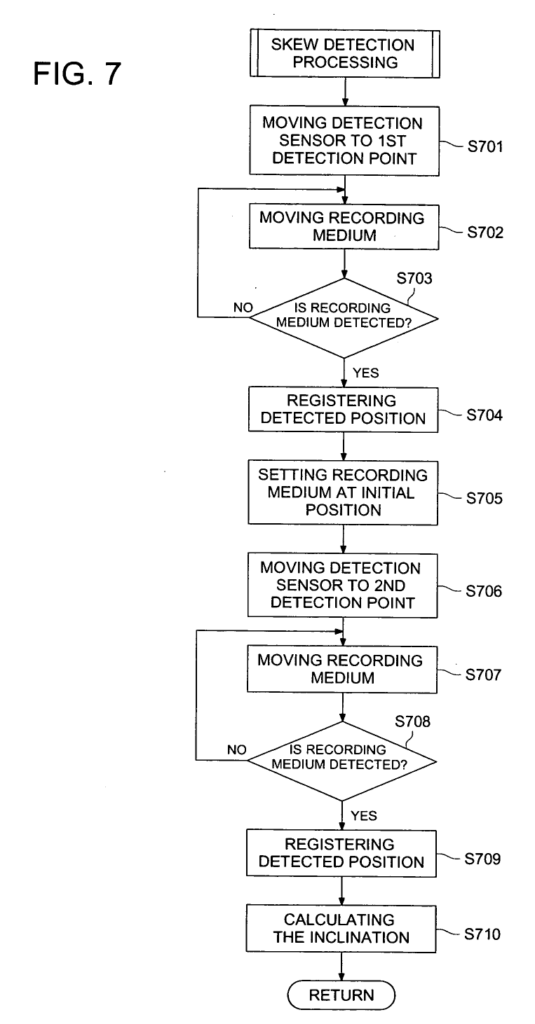

FIG. 7 is a flow chart of the skew detection processing. Firstly, the control section 110 moves the detection sensor 160 to the first detection point in the primary scanning direction (Step S701). In this case, the first detection point, as shown in FIG. 9(A), is positioned at the distance on the right away from the left edge of the printing area by L. The distance L, as shown in FIG. 9(A), when the recording medium 7 is moved in the sub-scanning direction, so that the leading edge of the recording medium 7 surely passes the spot position of the detection sensor 160, is set to a sufficient distance from the left edge of the printing area.

Thereafter, the control section 110 moves the recording medium 7 in the sub-scanning direction from the initial arrangement position (Step S702) and decides whether the detection sensor 160 positioned at the first detection point detects the recording medium 7 or not (Step S703). In FIG. 9(A), at the time of paper moving, the moving position of the spot of the detection sensor 160 positioned at the first detection point is shown by a dotted line. When the detection sensor 160 does not detect the recording medium 7 (No at Step S703), the process goes to Step S702 and the moving of the recording medium 7 and the detection of the recording medium 7 by the detection sensor 160 are repeated until the recording medium 7 is detected. When the detection sensor 160 detects the leading edge of the recording medium 7 (Yes at Step S703), it reads the position of the recording medium 7 in the sub-scanning direction at this time from the position information input section 125. And, the detection sensor 160 registers the first detection position of the recording medium 7 in the printing area from the distance L and the position in the sub-scanning direction (Step S704). In the example shown in FIG. 9(A), the intersection point A of the dotted line indicating the movement of the first detection point with the leading edge is detected.

Thereafter, the control 110 moves and returns the recording medium 7 to the initial arrangement position opposite to the ejection destination in the sub-scanning direction (Step S705). And, the control section 110 moves the detection sensor 160 to the second detection point in the primary scanning direction (Step S701). In this case, the second detection point, as shown in FIG. 9(A), is positioned at the distance R on the left from the right edge of the printing area. The distance R, as shown in FIG. 9(A), when the recording medium 7 is moved, so that the leading edge of the recording medium 7 surely passes the spot position of the detection sensor 160, is set to a sufficient distance from the right edge of the printing area.

Thereafter, the control section 110 moves the recording medium 7 in the sub-scanning direction from the initial arrangement position (Step S707) and decides whether the detection sensor 160 positioned at the second detection point detects the recording medium 7 or not (Step S708). In FIG. 9(A), at the time of paper moving, the moving position of the spot of the detection sensor 160 positioned at the second detection point is shown by a dotted line. When the detection sensor 160 does not detect the recording medium 7 (No at Step S708), the process goes to Step S707 and the moving of the recording medium 7 and the detection of the recording medium 7 by the detection sensor 160 are repeated until the recording medium 7 is detected. When the detection sensor 160 detects the leading edge of the recording medium 7 (Yes at Step S708), it reads the position of the recording medium 7 in the sub-scanning direction at this time from the position information input section 125. And, the detection sensor 160 registers the second detection position of the recording medium 7 in the printing area from the distance R and the position in the sub-scanning direction (Step S709). In the example shown in FIG. 9(A), the intersection point B of the dotted line indicating the movement of the second detection point with the leading edge is detected.

Thereafter, the control section 110, from the first and second detection positions at the leading end of the recording medium 7, that is, the points A and B in the example shown in FIG. 9(A), calculates the inclination of the recording medium 7 in the printing area (Step S710). And, the control section 110 returns to the leading edge detection processing shown in FIG. 6.

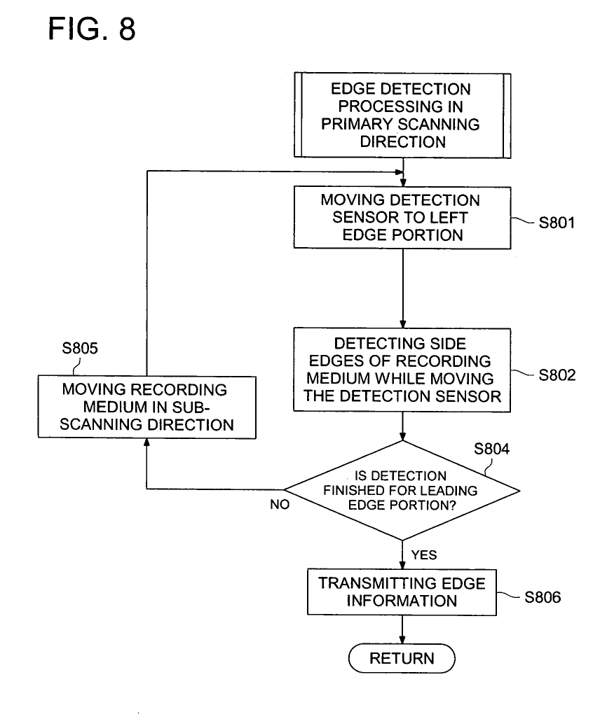

FIG. 8 is a flow chart showing the operation of the edge detection processing in the primary scanning direction. Here, the position of the recording medium 7 in the sub-scanning direction is detected following the skew detection processing shown in FIG. 7. Firstly, the control section 110 moves the detection sensor 160 to the left end of the printing area in the primary scanning direction shown in FIG. 9(A) (Step S801). And, the control section 110, while moving the detection sensor 160 in the primary scanning direction, detects the end portion which is the edge of the recording medium 7 (Step S802). Further, the end portion of the recording medium 7 is detected following the detection of the leading edge by the skew detection processing, so that as shown in FIG. 9(A), two end portions are always detected.

Thereafter, the control section 110, when printing the leading edge portion of the recording medium 7, for example, the recording medium 7, decides whether the detection of the edges of the printing area which are all read by the head is finished or not (Step S804). When the detection of the leading edge portion is not finished (No at Step S804), the control section 110 moves the recording medium 7 in the sub-scanning direction (Step S805), then goes to Step S801, and additionally detects the edges at the position of the recording medium 7 in the direction of the rear edge in the primary scanning direction. When the detection of the leading edge portion is finished (Yes at Step S804), the control section 110 transmits the detected rear edge information of the recording medium 7 to the mask generator 111 (Step S806) and finishes the processing.

FIG. 9(a) shows the edge detection processing in the primary scanning direction. The control section 110, following the detection of the points A and B at the leading edge by the skew detection processing, detects the end portions C and D of the left and right edges and additionally performs the detection operation similar to the detection of the end portions E and F by paper moving in the sub-scanning direction for overall the leading edge portion. Further, when the two end portions detected by scanning in the primary scanning direction are the end portions belonging to the left and right edges, the end portions always have an interval of equal distance in the primary scanning direction and the two end portions detected at the leading edge or rear edge are distinguished because the interval is smaller.

Thereafter, as shown in FIG. 5 again, the control section 110, using the data converter 112, sets the leading edge mask position in the printing area of the frameless image information (Step S503). In the setting of the leading edge mask position, from the inclination of the recording medium 7 and edge information which are obtained by the skew detection processing at Step S601 and the edge detection processing in the primary scanning direction at Step S602, the control section 110 masks the part of the printing area where the recording medium 7 does not exist. Concretely, the converter 112 substitutes a zero for the frameless image information of the memory section 130 in the printing area where the recording medium 7 does not exist and preserves it in the image memory section 123.

In FIG. 9(a), the mask area set in the printing area is shown. Using the points A and B positioned at the leading edge of the recording medium 7 obtained at Step S502 shown in FIG. 5 and the end portions C, D, E, and F positioned on the left and right edges, the position of the leading end portion of the recording medium 7 in the printing area is decided. Here, in the mask area where the recording medium 7 does not exist which is indicated by the hatched area in FIG. 9(a), a zero is substituted for the frameless image information in this area.

Thereafter, the control section 110 reads the frameless image information in the leading end portion by the image readout section 122 and using the head of the carriage section 121, carries out printing in the primary scanning direction with a predetermined width in the sub-scanning direction (Step S504). Further, in the movement of the carriage 2 in the primary scanning direction and the moving of the recording medium 7 in the sub-scanning direction which are to be performed during printing, the end portion of the recording medium 7 is simultaneously detected by the detection sensor 160 (Step S504).

Thereafter, the control section 110, by the detection sensor 160, decides whether the rear end portion including the rear edge of the recording medium 7 is detected or not (Step S505). Here, whether the rear edge is detected or not is detected, as mentioned above, by that the distance between the two end portions detected by movement of the detection sensor 160 in the primary scanning direction is reduced. When the rear end is not detected (No at Step 505), on the basis of the end portion information at the left and right edges of the recording medium 7 which is newly obtained at Step S504, the control section 110 renews the mask area (Step S507), moves the recording medium 7 in the sub-scanning direction (Step S506), goes to Step S504, and sequentially repeats printing.

Further, the control section 110, when the rear end is detected (Yes at Step S505), sets the rear end mask area (Step S508). The setting of the rear end mask area, assuming that the rear end has the same inclination as that of the leading end of the recording medium 7 obtained by the skew detection processing at Step S601 to the printing area, is performed exactly in the same way as with the leading end portion. Namely, the mask area in the printing area where the recording medium 7 does not exist is set by the mask generator 111 and a zero is substituted for the frameless image information existing in the mask area by the data converter 112. And, the frameless image information in the rear end portion is preserved in the image memory section 123. In the example shown in FIG. 9(b), the point H positioned at the rear edge of the recording medium 7 is detected. The inclination of the rear edge is assumed as equal to that of the leading edge, so that the part from the point H to the rear edge is uniquely decided.

Thereafter, the control section 110 reads the frameless image information in the rear end portion of the image memory section 123 by the image readout section 122 and prints in the rear end portion (Step S509). Thereafter, the control section 110 ejects the recording medium 7 in the sub-scanning direction and finishes the processing.

As described above, in this embodiment 1, the detection sensor 160 detects the position of the recording medium 7 in the printing area with high precision and generates the mask area where the recording medium 7 does not exist in the printing area by the mask generator 111 from the position information and the data converter 112 replaces and outputs the frameless image information in the mask area with a zero, so that in the area in the printing area where the recording medium 7 does not exist, frameless printing can be carried out in the recording medium 7 without ejecting ink and the frameless printing can be carried out without ejecting useless ink as well on the platen 8 of the recording medium 7 positioned on the opposite side of the carriage 2.

Further, in the embodiment 1, the memory section 130 for storing the frameless image information and the image memory section 123 for storing the frameless image information in which a zero is substituted for the part in the printing area where the recording medium 7 does not exist are separately installed, though these memory sections can operated as the same one.

### Embodiment 2

Meanwhile, in the aforementioned embodiment 1, a zero is substituted for the part of the frameless image information existing in the memory section where the recording medium 7 does not exist, and the result is read, thus ink is prevented from ejecting on the part of the printing area where the recording medium 7 does not exist. However, when reading images, on the basis of the mask area information, a zero can be outputted. Therefore, in the embodiment 2, a case that the mask area information is input to the image readout section 122 is indicated.

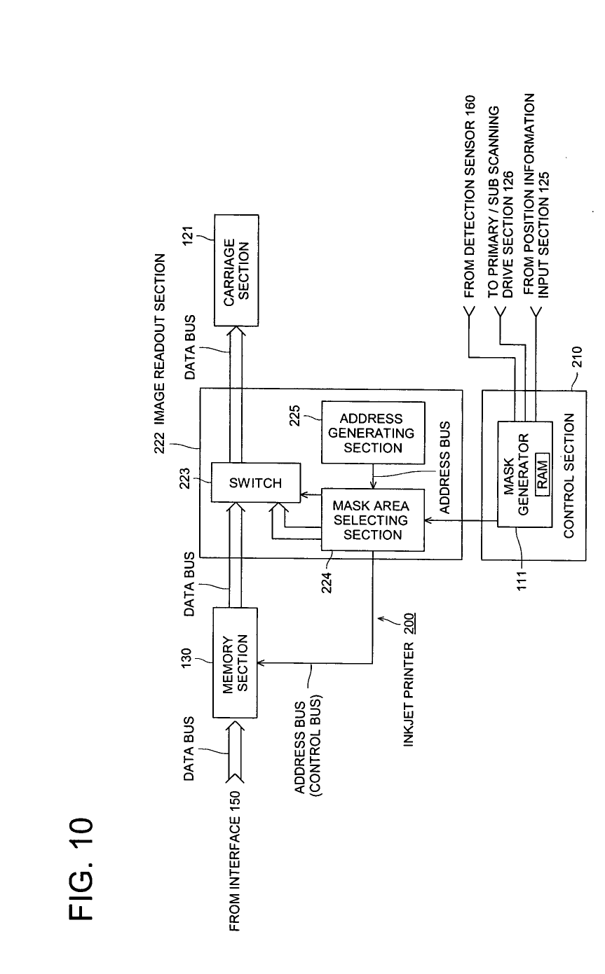

FIG. 10 is a block diagram of an ink jet printer 200 around an image readout section 222 relating to this embodiment 2. Here, the sections other than the interface 150, the memory section 130, and the image memory section 123 and the image readout section 122 of the recording section are exactly the same as those of the ink jet printer 100, so that they are neither shown in the drawing nor explained. Further, a control section 210 corresponds to the control section 110 and the image readout section 222 corresponds to the image readout section 122.

The control section 210 does not have the data converter 112 of the control section 110 and has the mask generator 111 which is the same as the control section 110. The image readout section 222 has a switch 223, an address generating section 225, and a mask area selecting section 224.

The mask generator 111, exactly in the same way as with the embodiment 1, sets a mask area in a two-dimensional data area having the same size as that of the printing area and temporarily preserves it in the RAM. And, the mask generator 111 outputs the mask area information to the mask are selecting section 224 of the image readout section 222. Further, the address generating section 225 of the image readout section 222 generates a readout address of the frameless image information of the memory section 130.

The mask area selecting section 224 compares address information from the address generating section 225 with mask area information from the mask generator 111 and when the address information is the mask area, outputs zero data to the switch 223. Further, when the address information is not the mask area, the mask area selecting section 224 outputs the address information to the memory section 130 as it is and outputs the corresponding frameless image information to the data bus.

The switch 223 switches the frameless image information from the memory section 130 and the zero data from the mask area selecting section 224 on the basis of the mask area information from the mask area selecting section 224 and outputs it to the carriage section 121.

As described above, in this embodiment 2, using the mask area selecting section 224 and the switch 223, on the basis of the mask area information, when the address information is the mask area, a zero is output, and when the address information is not the mask area, the frameless image information of the corresponding address is output, so that the mask area is prevented from ink ejection, and in the printing area other than the mask area, the frameless image information is output, and frameless printing free of ink ejection can be carried out in the mask area where the recording medium 7 does not exist.

(Effects of the Invention)

As explained above, according to the embodiments of the present invention, the following effects can be produced.

(1) The carriage detects by the detection means whether a recording medium exists at the detection point in the opposite position or not, and the control section, by the mask generating means, by movement of the detection point on the recording medium by scanning of the detection means and moving of the recording medium, obtains side edge position information of the recording medium, and on the basis of the side edge position information, when printing frameless image information, generates mask area information of masking the printing area where no recording medium exists, and on the basis of the mask area information, by the data converting means, masks the frameless image information, and the recording means, on the basis of the masked frameless image information, prints only the image information excluding the mask area of the frameless image information on the recording medium, so that in the mask area of the printing area where no recording medium exists, the frameless printing is carried out free of ink ejection and the platen behind the recording medium can be prevented from ink ejection as well.

(2) The recording means, by the image memory section for preserving the image information of only the printing part of the frameless image information and the image readout means, reads the image information from the image memory section, so that the image information can be effectively read and printed.

(3) The frameless image information masked by the image memory section can be preserved, so that ink ejection can be prevented in the mask area without changing the image readout means.

(4) Ink ejection in the mask area from the head can be eliminated simply.

(5) The carriage detects by the detection means whether a recording medium exists at the detection point in the opposite position or not, and the control section, by the mask generating means, by movement of the detection point on the recording medium by scanning of the detection means and moving of the recording medium, obtains side edge position information of the recording medium, and on the basis of the side edge position information, when printing frameless image information, generates mask area information of masking the printing area where no recording medium exists, and the recording means, on the basis of the mask area information, prints only the image information excluding the mask area of the frameless image information of the memory section, so that in the mask area of the printing area where no recording medium exists, the frameless printing is carried out free of ink ejection and the platen behind the recording medium can be prevented from ink ejection as well.

(6) The recording means, by the image memory section for preserving the image information of only the printing part of the frameless image information and the image readout means, reads the image information from the image memory section, so that the image information can be effectively read and printed.

(7) The frameless image information of the memory section can be used as it is without data conversion.

(8) The image information in the printing area is read with a width in the sub-scanning direction and can be printed effectively.

(9) The rear edge of the rear end portion of a recording medium can be detected before printing, and on the basis of this information, a precise mask area is prepared, thus ink ejection on the platen can be prevented.

(10) The photosensor of the detection means has a light source including red or an infrared zone, so that black ink on a recording medium can be distinguished from the platen, and confusion is prevented, thus the side edges can be detected with high precision.

(11) The linear type photosensor has photosensors arranged one-dimensionally, so that the position of each detection point can be detected more precisely and particularly, at the leading edge and rear edge directing almost in the same direction as the primary scanning direction in which the photosensors move, a precise side edge position can be detected.

(12) The control means, by the detection means which is positioned in the neighborhood of the center in scanning in the primary scanning direction, at the time of paper moving, detects that a recording medium passes the opposite position of the head, so that it can perform the same function as that of the photosensor on the base whereon the recording medium is loaded.

(13) The control means, by the skew detection means, during paper moving, scans the carriage several times in the primary scanning direction and detects the skew of a recording medium, so that it accurately decides the mask area including the skew and can prevent the mask area where no recording medium exists from ink ejection.

(14) When setting a mask area in the frameless image information, the mask position can be identified easily.

What is claimed is:

1. An ink jet printer for printing a frameless image on a recording medium, comprising:
an input section for receiving image data;
a recording section having a nozzle for ejecting an ink based on the image data;
a carriage for reciprocating the recording section in a primary scanning direction;
a recording medium moving section for moving the recording medium in a sub-scanning direction perpendicular to the primary scanning direction, relatively to the recording medium;
a detection sensor provided on the carriage for detecting an existence of the recording medium, wherein a detection position of the sensor is set on upstream side of the nozzle in a movement direction of the recording medium;
a first memory for storing the image data received;
a masking section, in accordance with recording medium existence information detected by the detection sensor, for applying masking processing to image data corresponding to outside of the recording medium among the image data in the first memory; and
a control section for controlling the ink jet printer to print an image on the recording medium by using the image data applied the masking processing.

2. The ink jet printer of claim 1, further comprising a second memory for storing the image data applied the masking processing, wherein the control section transmits the image data in the second memory to the recording section.

3. The ink jet printer of claim 2, wherein the masking processing is a processing to convert the image data corresponding to outside of the recording medium into data for preventing ink ejection from the nozzle.

4. The ink jet printer of claim 3, wherein the data for preventing ink ejection from the nozzle are data of zero.

5. The ink jet printer of claim 1, wherein the masking section comprises a third memory for temporarily storing a position information based on information of the recording medium existence detected by the detection sensor, and the masking section applies the masking processing to the image data based on the position information stored in the third memory, while reading out the image data from the first memory.

6. The ink jet printer of claim 5, wherein the position information is two-dimensional masking position information.

7. The ink jet printer of claim 5, wherein the masking processing is a processing to convert the image data corresponding to outside of the recording medium into data for preventing ink ejection from the nozzle.

8. The ink jet printer of claim 5, wherein the data for preventing ink ejection from the nozzle are data of zero.

9. The ink jet printer of claim 1, wherein the detection sensor comprises a photo sensor provided with a light source of red light or light including infrared light.

10. The ink jet printer of claim 1, wherein the control section controls the detection sensor to position in vicinity of center in the primary scanning direction, and when the recording medium is moved the detecting sensor detects the recording medium passing through a position opposite to the detecting sensor.

11. The ink jet printer of claim 1, wherein the control section comprises a skew detector for detecting a skew of the recording medium by moving the carriage in the primary scanning direction plural times while the recording medium moving section moves the recording medium.

12. An ink jet printer for printing a frameless image on a recording medium, comprising:
an input section for receiving image data;
a recording section having a nozzle for ejecting an ink based on the image data;
a carriage for reciprocating the recording section in a primary scanning direction;
a recording medium moving section for moving the recording medium in a sub-scanning direction perpendicular to the primary scanning direction, relatively to the recording medium;
a linear type photosensor provided over the primary scanning direction for detecting an existence of the recording medium, wherein a detection position of the linear type photosensor is set on upstream side of the nozzle in a movement direction of the recording medium;
a first memory for storing the image data received;
a masking section, in accordance with recording medium existence information detected by the detection sensor, for applying masking processing to image data corresponding to outside of the recording medium among the image data in the first memory; and
a control section for controlling the ink jet printer to print an image on the recording medium by using the image data applied the masking processing.

13. The ink jet printer of claim 12, further comprising a second memory for storing the image data applied the masking processing, wherein the control section transmits the image data in the second memory to the recording section.

14. The ink jet printer of claim 13, wherein the masking processing is a processing to convert the image data corresponding to outside of the recording medium into data for preventing ink ejection from the nozzle.

15. The ink jet printer of claim 12, wherein the masking section comprises a third memory for temporarily storing a position information based on information of the recording medium existence detected by the detection sensor, and the masking section applies the masking processing to the image data based on the position information stored in the third memory while reading out the image data from the first memory.

16. The ink jet printer of claim 15, wherein the masking processing is a processing to convert the image data corresponding to outside of the recording medium into data for preventing ink ejection from the nozzle.
